(19) United States
(12) Patent Application Publication
(10) Pub. No.: US 2026/0132068 A1
(43) Pub. Date: May 14, 2026

(54) SHEET GLASS THICKNESS CONTROL APPARATUS

(71) Applicant: CORNING INCORPORATED, CORNING, NY (US)

(72) Inventors: Derwin Lee Lamberson, Painted Post, NY (US); HungCheng Lu, Ithaca, NY (US); Robert Allan Tucker, Beaver Dams, NY (US)

(21) Appl. No.: 19/119,443

(22) PCT Filed: Oct. 10, 2023
(86) PCT No.: PCT/US2023/034781

§ 371 Date: Apr. 9, 2025

Related U.S. Application Data
(60) Provisional application No. 63/417,825, filed on Oct. 20, 2022.

(51) Int. Cl. C03B 17/06

(52) U.S. Cl. CPC C03B 17/064; C03B 17/067; C03B 17/068

(57) ABSTRACT

A fusion draw apparatus includes a housing, a forming member, and at least one door. The housing defines an opening. The forming member includes a first exterior surface and a second exterior surface. A thickness at a first end of the forming member is greater than a thickness at a second end of the forming member. Molten glass flows along the first exterior surface and the second exterior surface toward the second end of the forming member. The second end is positioned proximate to the opening. The at least one door is positioned proximate to the opening. The at least one door defines a cavity therein. The cavity is provided with a plurality of dividers. Adjacent dividers define a chamber. Each chamber receives a fluid conduit.

### CROSS-REFERENCE TO RELATED APPLICATIONS

This application claims the benefit of priority under 35 U.S.C. § 119 of U.S. Provisional Application No. 63/417,825 filed Oct. 20, 2022, the content of which is incorporated herein by reference in its entirety.

### FIELD OF INVENTION

This disclosure pertains to a glass fusion draw apparatus, and more specifically to a fusion draw apparatus that includes a housing, a forming member, and at least one door that defines a cavity.

### BACKGROUND

Sheet glass forming processes can be affected by thickness uniformity of the sheet glass. Additionally, properties of the final product sheet glass can be impacted by thickness uniformity. For example, optical properties, surface roughness, sheet stress, sheet shape, among others, can be impacted by thickness uniformity. Accordingly, thickness uniformity is an important sheet glass attribute. Warp is a glass sheet defect characterized by deviation from a plane. It can be a troublesome, problematic, and persistent problem in various industries and in the manufacture of various products. These industries and products include the semiconductor packaging industry and liquid crystal displays (LCDs). One source of warp can be from thickness variations and/or inconsistencies, each of which can result in a non-uniform cooling profile within the sheet glass during the forming process.

Accordingly, a need exists for alternative arrangements that are capable of controlling a thickness profile and improving across-the-sheet cooling uniformity of the glass sheet.

### SUMMARY

According to one embodiment, a fusion draw apparatus includes a housing, a forming member, and at least one door. The housing defines an opening. The forming member includes a first exterior surface and a second exterior surface. A thickness at a first end of the forming member is greater than a thickness at a second end of the forming member. Molten glass flows along the first exterior surface and the second exterior surface toward the second end of the forming member. The second end is positioned proximate to the opening. The at least one door is positioned proximate to the opening. The at least one door defines a cavity therein. The cavity is provided with a plurality of dividers. Adjacent dividers define a chamber. Each chamber receives a fluid conduit.

According to another embodiment, a fusion draw apparatus includes a housing, a forming member, and at least one door. The housing defines an opening. The forming member includes a first exterior surface and a second exterior surface. A thickness at a first end of the forming member is greater than a thickness at a second end of the forming member. Molten glass flows along the first exterior surface and the second exterior surface toward the second end of the forming member. The second end is positioned proximate to the opening. The at least one door is positioned proximate to the opening. The at least one door defines a cavity therein. The cavity is provided with a plurality of dividers. Adjacent dividers define a chamber. Each chamber receives a fluid conduit. The at least one door includes a front wall, a rear wall, and an intermediate wall. The intermediate wall is positioned between the front wall and the rear wall. Each of the plurality of dividers extends between the front wall and the intermediate wall. The intermediate wall defines a plurality of apertures. Each of the plurality of apertures corresponds with one of the chambers. The fluid conduit that corresponds with each chamber passes through the corresponding one of the plurality of apertures defined by the intermediate wall. The rear wall of the at least one door defines at least one exit port.

Additional features and advantages will be set forth in the detailed description that follows, and in part will be readily apparent to those skilled in the art from that description or recognized by practicing the embodiments as described herein, including the detailed description that follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a front view of a fusion draw apparatus, illustrating various components thereof and a cavity of one or more doors, according to one example;

FIG. 2 is a front view of the at least one door, illustrating an arrangement of the cavity of the door, according to one example;

FIG. 3 is a cross-sectional view, taken along line III-III of FIG. 2, illustrating a top view of the cavity of the door, according to one example; and

FIG. 4 is a rear view of the cavity of the door, taken along line IV-IV of FIG. 3, illustrating the arrangement of the cavity, according to one example.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

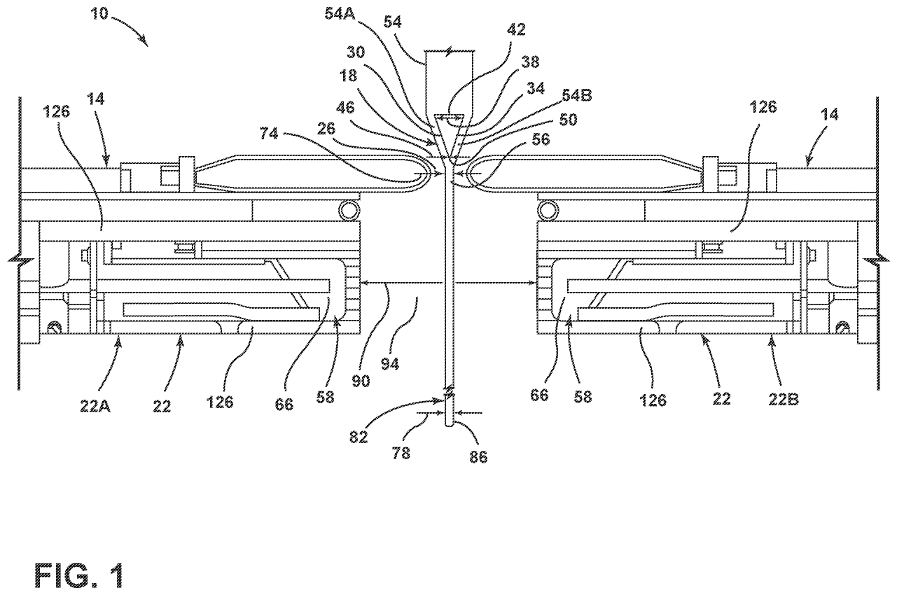

Referring to FIGS. 1-4, a portion of a fusion draw apparatus 10 is shown. The fusion draw apparatus 10 includes a housing 14, a forming member 18, and at least one door 22. The housing 14 defines an opening 26. The forming member 18 includes a first exterior surface 30 and a second exterior surface 34. A thickness 38 at a first end 42 of the forming member 18 is greater than a thickness 46 at a second end 50 of the forming member 18. Molten glass 54 may contact the first end 42 of the forming member 18 and flow along the first exterior surface 30 and the second exterior surface 34 toward the second end 50 of the forming member 18. Alternatively, two separate portions of the molten glass 54 may be individually introduced to either side of the forming member 18. For example, a first portion 54A of the molten glass 54 may flow along, or be introduced at, the first exterior surface 30 and a second portion 54B of the molten glass 54 may flow along, or be introduced at, the second exterior surface 34. The first and second portions 54A, 54B of the molten glass 54 are joined at or near the second end 50 of the forming member 18 (e.g., shortly after ceasing contact with the second end 50). When the first and second portions 54A, 54B of the molten glass 54 are joined, an intermediate glass sheet 56 is formed. The second end 50 of the forming member 18 is positioned proximate to the opening 26 that is defined by the housing 14. The at least one door 22 is positioned proximate to the opening 26. The at least one door 22 defines a cavity 58 therein. The cavity 58 is provided with a plurality of dividers 62. Adjacent dividers 62 define a chamber 66. Each chamber 66 receives a fluid conduit 70.

Referring again to FIG. 1, when the molten glass 54 is drawn into sheet form, the molten glass 54 is stretched or attenuated from an initial delivery thickness 74 to a final sheet thickness 78. The fusion draw apparatus 10 depicted may be employed in an overflow-downdraw process. In such a process, the molten glass 54 flows downwardly along the first exterior surface 30 and the second exterior surface 34 of the forming member 18 and is withdrawn as a single sheet from the second end 50 of the forming member 18. The first and second exterior surfaces 30, 34 are opposed converging sides of the forming member 18. The second end 50 of the forming member 18 is often referred to as a root. The initial delivery thickness 74 of the molten glass 54 can be measured close to the second end 50 of the forming member 18, which represents a draw line in such an operation. A uniformity of the final sheet thickness 78 is determined during the attenuation (i.e., cooling) process. The uniformity of the final sheet thickness 78 can be dependent on a uniformity of the initial delivery thickness 74 and a uniformity of a viscosity of the glass sheet. A given thickness variation in the final glass sheet may be the result of inaccurate metering, imperfections in the first and second exterior surfaces 30, 34 of the forming member 18, or by imbalances in a temperature environment of the glass that cause imperfections in the viscosity profile of the glass flowing toward the second end 50 of the forming member 18.

Thickness variation in the glass sheet may manifest itself in several general types of defects, such as, wedge, long period wave variations, and short period wave variations. Wedge is a gross thickness variation in which the sheet is thicker at one edge than an opposing edge. Long wave variations are those that have considerable amplitude and extent, such as in excess of several centimeters, and can be measured by measuring the thickness of the sheet along a path in a direction transverse to the direction of the draw. Short wave variations are of small amplitude and pitch, such as about eight centimeters or less, and are generally superimposed on the long wave variations.

It is an object of the fusion draw apparatus 10 of the present disclosure to minimize or compensate for local temperature variations or fluctuations within and around the molten glass 54 in an area of sheet formation (e.g., near the second end 50 of the forming member 18).

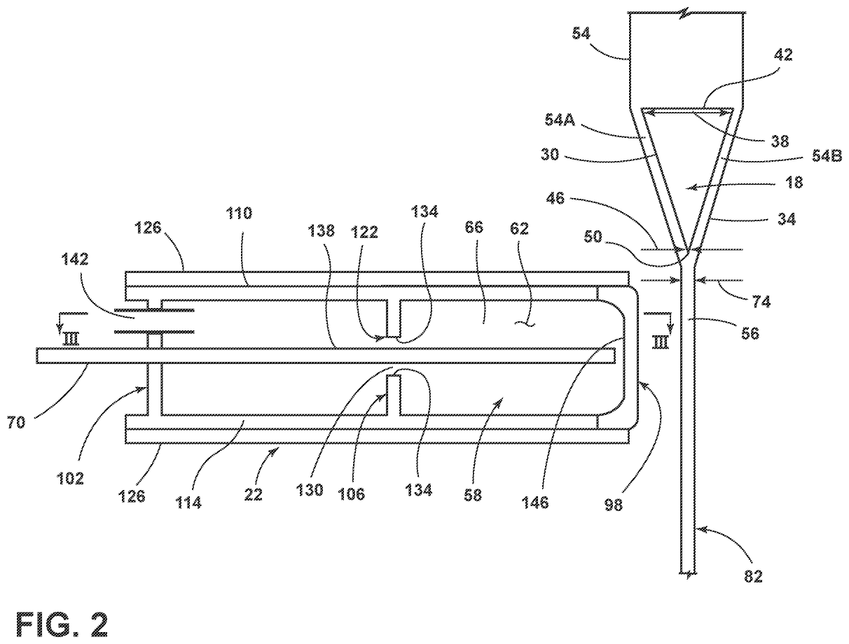

Referring now to FIGS. 1 and 2, a glass sheet 82 produced by the fusion draw apparatus 10 may be referred to as the intermediate glass sheet 56 after leaving the second end 50 of the forming member 18. The glass sheet 82 may be referred to as a final glass sheet 86 after passing by the at least one door 22 or after having been subjected to a final stage in the formation process. In the depicted example, the at least one door 22 can include a first door 22A and a second door 22B. The first door 22A is positioned on a first side of the opening 26 and the second door 22B is positioned on a second side of the opening 26. A distance 90 between the first door 22A and the second door 22B defines an orifice 94 therebetween. The orifice 94 aligns with the opening 26. For example, the orifice 94 and the opening 26 may be coaxially aligned with the glass sheet 82 defining a common axis of alignment. Said another way, the glass sheet 82 may pass through a centerline of the opening 26 and a centerline of the orifice 94 such that a cross-sectional overlap exists between the opening 26 and the orifice 94 along at least one plane (e.g., a vertical plane). The orifice 94 may be adjustable in size by adjusting the distance 90 between the first door 22A and the second door 22B. In some examples, the opening 26 may be fixed in size.

Referring to FIGS. 2-4, the at least one door 22 (e.g., the first door 22A and/or the second door 22B) each include a front wall 98, a rear wall 102, and an intermediate wall 106. The intermediate wall 106 is positioned between the front wall 98 and the rear wall 102. In the depicted example, the front wall 98, the rear wall 102, and the intermediate wall 106 are arranged parallel to one another. However, it is contemplated that the front wall 98, the rear wall 102, and/or the intermediate wall 106 may be arranged in a non-parallel relationship with at least one of the other walls of the door 22. For example, the front wall 98 may be non-parallel to the rear wall 102 and/or the intermediate wall 106 such that the glass sheet 82 is presented with a sloped surface of the door 22 at the front wall 98. In another example, the intermediate wall 106 may be arranged in a non-parallel relationship with the front wall 98 and/or the rear wall 102 such that a distance between the front wall 98 and the intermediate wall 106 at a top wall 110 of the chambers 66 differs from the distance between the front wall 98 and the intermediate wall 106 at a bottom of the chambers 66.

Referring again to FIGS. 2-4, in various examples, the at least one door 22 can include silica carbide. For example, the front wall 98 may be made, at least in part, of silica carbide. In some examples, the plurality of dividers 62, the front wall 98, the rear wall 102, the intermediate wall 106, the top wall 110, the bottom wall 114, and/or sidewalls 118 of the at least one door 22 may be made, at least in part, of silica carbide. In one specific example, the plurality of dividers 62, the front wall 98, the rear wall 102, the intermediate wall 106, the top wall 110, the bottom wall 114, and the sidewalls 118 of the at least one door 22 are each entirely made of silica carbide. Each of the plurality of dividers 62 extends between the front wall 98 and the intermediate wall 106. The intermediate wall 106 defines a plurality of apertures 122. Each of the plurality of apertures 122 corresponds with one of the chambers 66. Said another way, the intermediate wall 106 can be consider a back wall of each of the chambers 66, where the back wall of the given chamber 66 defines one of the plurality of apertures 122 therein. The fluid conduit 70 that corresponds with each chamber 66 passes through the corresponding one of the plurality of apertures 122 that is defined by the intermediate wall 106. Said another way, each of the plurality of apertures 122 receives one of the fluid conduits 70. Accordingly, the fluid conduit 70 enters the chamber 66 through the corresponding aperture 122.

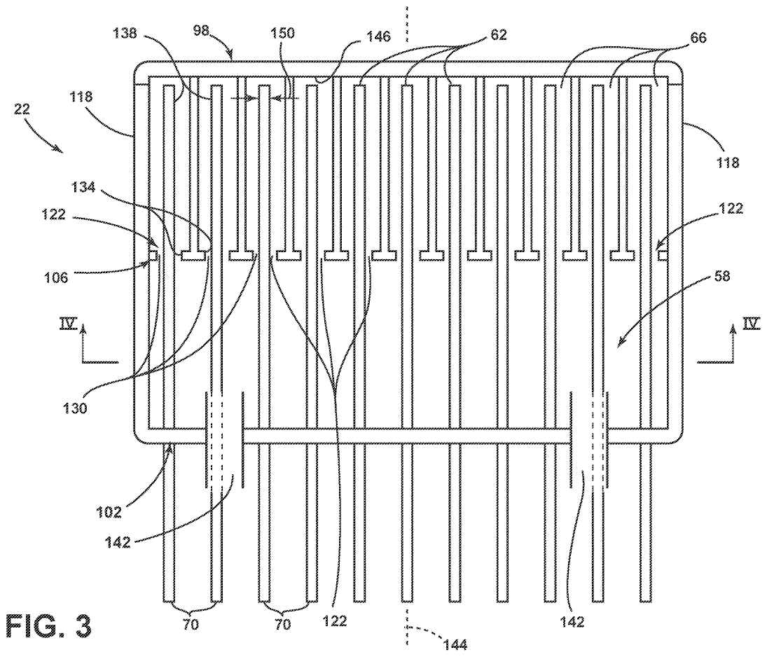

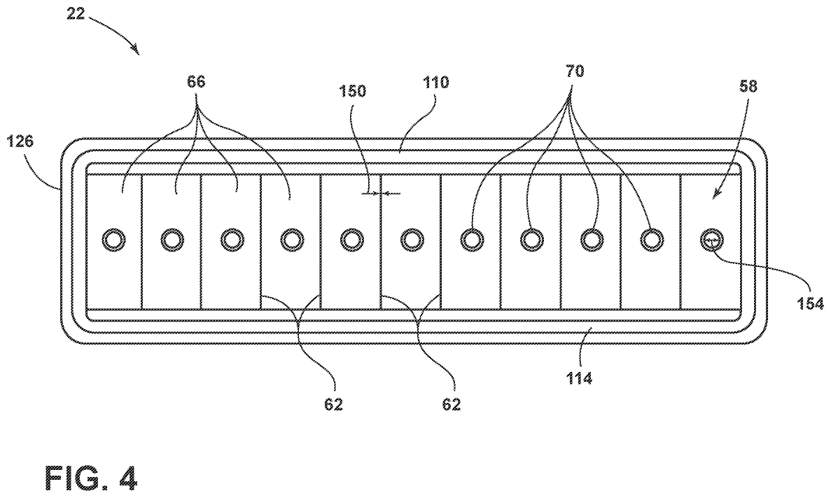

Referring further to FIGS. 2-4, each chamber 66 may be substantially free of insulation material in at least one plane (e.g., a vertical plane, a horizontal plane, or a diagonal plane). In one specific example, the at least one plane through which the chamber 66 is substantially free of insulation can extend through the fluid conduit 70 and an immediately adjacent one of the plurality of dividers 62 (e.g., see FIGS. 3 and 4). Insulation material 126 may be provided along at least a portion of an exterior of the at least one door 22. For example, the insulation material 126 may be provided along an exterior surface of the top wall 110 and an exterior surface of the bottom wall 114. In some examples, the insulation material 126 may extend along exterior surfaces of the top wall 110, the bottom wall 114, and the sidewalls 118. In various examples, the exterior surfaces of the front wall 98 and the rear wall 102 may be free of the insulation material 126. It may be beneficial to maintain the interior of the at least one door 22 as completely free of the insulation material 126. For example, by maintaining the cavity 58 and the plurality of chambers 66 as free of the insulation material 126, fluid (e.g., gas and/or liquid) that is introduced through the fluid conduits 70 may be permitted a less restricted environment or flow path. Such an arrangement may provide more rapid exchange of the fluid delivered by the fluid conduits 70.

Referring still further to FIGS. 2-4, a temperature of the fluid delivered through the fluid conduits 70 may be room temperature (e.g., about 20° C. to about 25° C.). Accordingly, the fluid delivered through the fluid conduits 70 may not be actively cooled. Alternatively, the fluid delivered through the fluid conduits 70 may be actively cooled such that the temperature of the fluid is less than room temperature. In various examples, the fluid delivered through the fluid conduits 70 may be provided from a pressurized environment (e.g., from a storage tank). In such an example, the fluid delivered through the fluid conduits 70 may not be actively cooled while also being delivered at a temperature that is less than room temperature. For example, releasing the fluid from the pressurized environment may result in an expansion of the fluid (e.g., gas) that provides a decrease in temperature of the fluid that corresponds with the decrease in pressure. Such a phenomenon may be explained, at least in part, by the ideal gas law. The fluid conduits 70 may be individually provided with fluid such that each fluid conduit 70 is individually coupled to a source of the fluid delivered through the fluid conduits 70. Alternatively, the fluid conduits 70 may be commonly provided with the fluid such that each fluid conduit 70 is plumbed to a junction and the junction is directly coupled to the source of fluid.

Referring again to FIGS. 2-4, a gap 130 is defined between edges 134 of each of the plurality of apertures 122 and an outer surface 138 of the corresponding fluid conduit 70. The gap 130 may aid in a more rapid exchange of the fluid delivered by the fluid conduits 70. The rear wall 102 of the at least one door 22 defines at least one exit port 142. Fluid that is delivered to the cavity 58 and/or the chamber(s) 66 exits the at least one door 22 by way of the exit port(s) 142. The exit port(s) 142 of the depicted example are positioned in an upper region of the cavity 58 and closer to the sidewalls 118 than a centerline 144 of the cavity 58. However, the present disclosure is not so limited. Rather, the exit port(s) 142 may be positioned at any suitable location along a vertical direction and/or a horizontal direction of the rear wall 102. Any suitable number of the exit port 142 may be employed.

Referring further to FIGS. 2-4, in operation, fluid passes through the fluid conduit 70 and exits the fluid conduit 70 to enter the corresponding chamber 66. After exiting the fluid conduit 70, the fluid contacts an interior surface 146 of the front wall 98. After contacting the interior surface 146 of the front wall 98, the fluid is directed toward the intermediate wall 106 as a result of the construction of the chamber 66 (e.g., contours, positioning of components, etc.) and a pressure of the fluid exiting the fluid conduit 70. At the intermediate wall 106, the fluid exits the chamber 66 by way of the corresponding one of the plurality of apertures 122. More specifically, the fluid exits the chamber 66 by way of the gap 130 between the edges 134 of the aperture 122 and the outer surface 138 of the fluid conduit 70. Once the fluid has exited the chamber 66, the fluid passes through the portion of the cavity 58 that is between the intermediate wall 106 and the rear wall 102. At the rear wall 102, the fluid exits the cavity 58 through the exit port(s) 142.

Referring yet again to FIGS. 2-4, the dividers 62 prevent fluid from one of the chambers 66 from affecting immediately adjacent, or neighboring, ones of the chambers 66. The number of chambers 66 may be chosen based on a size of the at least one door 22 and/or a desired thermal profile of the front wall 98 without departing from the concepts discussed herein. For example, while a plurality of chambers 66 are depicted, one or more chambers 66 may be defined within the cavity 58 depending upon design requirements. In the depicted example, the intermediate wall 106 is approximately equidistant from the front wall 98 and the rear wall 102. Accordingly, the volume of the cavity 58 between the intermediate wall 106 and the front wall 98 may be about equal to the volume of the cavity 58 between the intermediate wall 106 and the rear wall 102. However, the present disclosure is not so limited. Rather, a proportion of the cavity 58 that is dedicated to the chambers 66 may be chosen based on various design requirements. For example, the design requirements may include, but are not limited to, rate of exchange for the fluid, pressure within the cavity 58, pressure within the chambers 66, and/or temperature of the front wall 98.

Referring still further to FIGS. 2-4, the gap 130 between the edges 134 of the aperture 122 and the outer surface 138 of the fluid conduit 70 may be chosen or adjusted to provide a desired degree of pressure within the chamber 66. Similarly, a size of the exit port(s) 142 may be chosen or adjusted to provide the desired degree of pressure within the cavity 58. Additionally, a relative size of the gap(s) 130 and the exit port(s) 142 may be chosen or adjusted to provide a desired degree of exchange between fluid exiting the fluid conduit 70 and fluid exiting the cavity 58. A delivery pressure of the fluid through the fluid conduit 70 may be chosen or adjusted by varying a pressure of the fluid (e.g., adjusting volume per unit time) or by adjusting a size of the fluid conduit 70. In general, a volume of the cavity 58, a volume of the chamber 66, a size of the fluid conduit(s) 70, a size of the gap(s) 130, a size of the exit port(s) 142, and the delivery pressure of the fluid may be chosen to attain a desired rate of exchange or a desired rate of replacement of the fluid within the cavity 58 and/or the chamber 66.

With specific reference to FIGS. 3 and 4, a thickness 150 of the dividers 62 may be less than about 5 mm. For example, the dividers 62 may each be less than about 5.0 mm, less than about 4.0 mm, less than about 3.0 mm, less than about 2.0 mm, less than about 1.0 mm, and/or combinations or ranges thereof. An inner diameter 154 of the fluid conduits 70 may be at least about 5 mm. For example, the inner diameter 154 of each of the fluid conduits 70 may be at least about 5.0 mm, at least about 10.0 mm, at least about 15.0 mm, and/or combinations or ranges thereof. In one specific example, the inner diameter 154 of each of the fluid conduits 70 may be at least about 9.0 mm.

It will be apparent to those skilled in the art that various modifications and variations can be made without departing from the spirit or scope of the claims.

What is claimed is:

1. A fusion draw apparatus, comprising:
a housing that defines an opening;
a forming member comprising a first exterior surface and a second exterior surface, wherein a thickness at a first end of the forming member is greater than a thickness at a second end of the forming member, wherein molten glass flows along the first exterior surface and the second exterior surface toward the second end of the forming member, and wherein the second end is positioned proximate to the opening; and
at least one door positioned proximate to the opening, wherein the at least one door defines a cavity therein, wherein the cavity is provided with a plurality of dividers, wherein adjacent dividers define a chamber, and wherein each chamber receives a fluid conduit.

2. The fusion draw apparatus of claim 1, wherein the at least one door comprises:
a front wall;
a rear wall; and
an intermediate wall positioned between the front wall and the rear wall.

3. The fusion draw apparatus of claim 2, wherein the front wall of the at least one door comprises silica carbide.

4. The fusion draw apparatus of claim 2, wherein each of the plurality of dividers extends between the front wall and the intermediate wall.

5. The fusion draw apparatus of claim 4, wherein the intermediate wall defines a plurality of apertures.

6. The fusion draw apparatus of claim 5, wherein each of the plurality of apertures corresponds with one of the chambers.

7. The fusion draw apparatus of claim 6, wherein the fluid conduit that corresponds with each chamber passes through the corresponding one of the plurality of apertures defined by the intermediate wall.

8. The fusion draw apparatus of claim 7, wherein a gap is defined between edges of each of the plurality of apertures and an outer surface of the corresponding fluid conduit.

9. The fusion draw apparatus of claim 7, wherein the rear wall of the at least one door defines at least one exit port.

10. The fusion draw apparatus of claim 9, wherein fluid that passes through the fluid conduit enters the corresponding chamber, wherein the fluid contacts the front wall after exiting the fluid conduit, and wherein the fluid exits the chamber at the corresponding one of the plurality of apertures.

11. The fusion draw apparatus of claim 1, wherein the at least one door comprises a first door and a second door.

12. The fusion draw apparatus of claim 11, wherein the first door is positioned on a first side of the opening and the second door is positioned on a second side of the opening.

13. The fusion draw apparatus of claim 12, wherein a distance between the first door and the second door defines an orifice therebetween, and wherein the orifice is aligned with the opening.

14. The fusion draw apparatus of claim 13, wherein the orifice is adjustable in size by adjusting the distance between the first door and the second door.

15. The fusion draw apparatus of claim 1, wherein each chamber is substantially free of insulation material in at least one plane, and wherein the at least one plane extends through the fluid conduit and an immediately adjacent one of the plurality of dividers.

16. A fusion draw apparatus, comprising:
a housing that defines an opening;
a forming member comprising a first exterior surface and a second exterior surface, wherein a thickness at a first end of the forming member is greater than a thickness at a second end of the forming member, wherein molten glass flows along the first exterior surface and the second exterior surface toward the second end of the forming member, and wherein the second end is positioned proximate to the opening; and
at least one door positioned proximate to the opening, wherein the at least one door defines a cavity therein, wherein the cavity is provided with a plurality of dividers, wherein adjacent dividers define a chamber, wherein each chamber receives a fluid conduit, and wherein the at least one door comprises:
a front wall;
a rear wall; and
an intermediate wall positioned between the front wall and the rear wall, wherein each of the plurality of dividers extends between the front wall and the intermediate wall, wherein the intermediate wall defines a plurality of apertures, wherein each of the plurality of apertures corresponds with one of the chambers, wherein the fluid conduit that corresponds with each chamber passes through the corresponding one of the plurality of apertures defined by the intermediate wall, and wherein the rear wall of the at least one door defines at least one exit port.

17. The fusion draw apparatus of claim 16, wherein a gap is defined between edges of each of the plurality of apertures and an outer surface of the corresponding fluid conduit, wherein fluid that passes through the fluid conduit enters the corresponding chamber, wherein the fluid contacts the front wall after exiting the fluid conduit, and wherein the fluid exits the chamber through the gap at the corresponding one of the plurality of apertures.

18. The fusion draw apparatus of claim 16, wherein the at least one door comprises a first door and a second door, wherein the first door is positioned on a first side of the opening and the second door is positioned on a second side of the opening, wherein a distance between the first door and the second door defines an orifice therebetween, wherein the orifice is aligned with the opening, and wherein the orifice is adjustable in size by adjusting the distance between the first door and the second door.

19. The fusion draw apparatus of claim 16, wherein each chamber is substantially free of insulation material in at least one plane, and wherein the at least one plane extends through the fluid conduit and an immediately adjacent one of the plurality of dividers.

20. The fusion draw apparatus of claim 16, wherein the front wall of the at least one door comprises silica carbide.
